(19) United States
(12) Patent Application Publication
(10) Pub. No.: US 2024/0304809 A1
(43) Pub. Date: Sep. 12, 2024

(54) NEGATIVE ELECTRODE PLATE AND ELECTROCHEMICAL APPARATUS AND ELECTRONIC DEVICE INCLUDING SAME

(71) Applicant: Ningde Amperex Technology Limited, Ningde (CN)

(72) Inventors: Shan ZHU, Ningde (CN); Ting GUAN, Ningde (CN); Fei WU, Ningde (CN)

(73) Assignee: Ningde Amperex Technology Limited, Ningde (CN)

(21) Appl. No.: 18/664,815

(22) Filed: May 15, 2024

Related U.S. Application Data
(63) Continuation of application No. PCT/CN2021/130699, filed on Nov. 15, 2021.

(51) Int. Cl. H01M 4/583; H01M 4/02; H01M 4/04; H01M 4/1393; H01M 4/1395; H01M 4/38; H01M 4/62

(52) U.S. Cl. CPC H01M 4/583; H01M 4/0404; H01M 4/0471; H01M 4/1393; H01M 4/1395; H01M 4/386; H01M 4/622; H01M 4/625; H01M 2004/021; H01M 2004/027

(57) ABSTRACT

A negative electrode plate and an electrochemical apparatus and electronic device including the same. A temperature corresponding to a peak height of the first peak on a DTG curve of the negative electrode plate is higher than 350° C.; and the negative electrode plate includes a negative electrode active material layer, the negative electrode active material layer includes a negative electrode active material, and an active specific surface area of the negative electrode material layer is greater than or equal to K·25 cm²/g, where K represents a correction parameter, K=15 m/Dᵥ50, and Dᵥ50 represents a median particle size of the negative electrode active material.

### CROSS-REFERENCE TO RELATED APPLICATIONS

This application is a continuation application of International Application No. PCT/CN2021/130699, filed on Nov. 15, 2021, the contents of which are incorporated herein by reference in its entirety.

### TECHNICAL FIELD

This application relates to the field of electrochemical technologies, and specifically, to a negative electrode plate and an electrochemical apparatus and electronic device including the same.

### BACKGROUND

With the advantages of high voltage, high specific energy, and long cycle life, lithium-ion batteries, as a type of efficient mobile energy sources, have been widely used in electronic products such as mobile phones, notebook computers, and digital cameras. Especially with the rapid popularization of smartphones in recent years, people have increasing requirements for the charging speed and energy density of lithium-ion batteries with energy storage. To solve the problem of the charging speed, materials and formulations of negative electrodes are usually adjusted to improve the kinetic performance of the negative electrodes. However, such adjustments on the materials and formulations of the negative electrodes lead to some processing problems and limited improvement on the kinetic performance. There is an urgent need to find a new way to solve the above problem.

### SUMMARY

This application provides a negative electrode plate with better kinetic performance, so as to allow for a faster charging speed of an electrochemical apparatus using the negative electrode plate.

A first aspect of this application provides a negative electrode plate, where a temperature corresponding to a peak height of the first peak on a derivative thermogravimetric curve (DTG curve) of a thermogravimetric curve (TG curve) of the negative electrode plate is higher than 350° C.; and the negative electrode plate includes a negative electrode active material layer, the negative electrode active material layer includes a negative electrode active material, and an active specific surface area of the negative electrode active material layer is greater than or equal to K·25 cm²/g, where K represents a correction parameter, K=15 μm/Dᵥ50, and Dᵥ50 represents a median particle size of the negative electrode active material.

The active specific surface area of the negative electrode active material layer in this application refers to a ratio of an active surface area of the negative electrode active material layer to a mass of the negative electrode active material layer and can be used to reflect the number of active sites during charge and discharge of the negative electrode plate. The inventors have found that a larger active specific surface area leads to a higher lithium precipitation window and a faster charging speed. The inventors have found in research that the active specific surface area of the negative electrode active material layer is related to a microstructure of the negative electrode active material layer and the median particle size of the negative electrode active material. The inventors of this application eliminate the influence of different particle sizes on the active specific surface area by using the correction parameter, and a value of the obtained active specific surface area more objectively reflects an internal microstructure of the active material layer. The negative electrode active material layer in this application has a higher active specific surface area. This indicates that the active material layer of the negative electrode plate in this application has a microstructure different from those of existing negative electrode active material layers.

The inventors have found that through thermogravimetric (TG) analysis of the negative electrode plate in this application, a temperature corresponding to the peak height of the first peak on the DTG curve (the derivative thermogravimetric curve of TG) is higher than 350° C. In addition, the negative electrode active material layer has a higher active specific surface area. The inventors have also found that the negative electrode plate has better kinetic performance, and an electrochemical apparatus using the negative electrode plate has a faster charging speed and better electrochemical performance. The “peak height” described in this application can be understood as a maximum value of the first peak.

In this application, the term “Dᵥ50” indicates a particle size at 50% cumulative volume distribution and is also called a median particle size, where particles whose size is less than the particle size have a cumulative volume accounting for 50% of the total volume of all particles.

In this application, min represents minutes.

In this application, the derivative thermogravimetric curve of the thermogravimetric curve can be obtained using conventional methods in the art. For example, it can be obtained using the following method: cutting the negative electrode plate into small discs with a diameter of 14 mm, performing thermogravimetric analysis test in a nitrogen atmosphere, with a test temperature rising from 25° C. to 600° C. at a temperature rise velocity of 10° C./min, to obtain a thermogravimetric curve, and performing derivative treatment on the thermogravimetric curve to obtain the derivative thermogravimetric curve of the thermogravimetric curve.

In some embodiments of this application, the median particle size Dᵥ50 of the negative electrode active material satisfies 100 nm≤Dᵥ50≤30 μm.

The type of the negative electrode active material is not limited in this application. For example, existing various constituents used as negative electrode active materials for lithium-ion batteries can be used as the negative electrode material, such as a graphite-based negative electrode material containing graphite and a silicon material containing at least one selected from the group consisting of silicon carbon and silicon oxide; or a hard carbon-based negative electrode material such as resin carbon, organic polymer pyrolytic carbon, and carbon black, or a composite negative electrode material obtained by mixing the foregoing different types of negative electrode materials in a specified proportion can be used. The inventors have found that different negative electrode materials have different particle size ranges. For example, Dᵥ50 of a silicon-based negative electrode material is typically 100 nm to 20 μm, and Dᵥ50 of the graphite-based negative electrode material is typically 10 μm to 30 μm. However, the inventors have found that when different negative electrode active materials are used, as compared with negative electrode plates obtained using prior-art methods, negative electrode active material layers of negative electrode plates obtained through treatment by a specific method (which will be described below in detail) in this application all have a larger active specific surface area.

In some embodiments of this application, the negative electrode active material layer further includes long-range fiber. The long-range fiber in this application includes some long-range conductive carbon, long-range ceramic fiber, long-range polymer fiber, or the like. The long-range conductive carbon refers to a conductive carbon material of a one-dimensional structure, such as at least one selected from the group consisting of carbon nanotubes and carbon nanofiber. The inventors have found that with a fibrous structure, the long-range fiber has increased contact with particles of a negative electrode active material and can significantly enhance cohesion of an electrode plate, allowing for a good suppress effect on swelling of the electrode plate of a lithium-ion battery prepared using the electrode plate during cycling, and avoiding loss of volumetric energy density of the lithium-ion battery during cycling. More fortuitously, the inventors have also found that the long-range fiber introduced can alleviate swelling of the lithium-ion battery but leads to deterioration of the kinetic performance of a battery cell, such as decrease of a lithium precipitation window, while after a negative electrode plate with the long-range fiber added is subjected to heat treatment using the method in this application, the negative electrode plate obtained can alleviate cycling swelling of the battery cell while guaranteeing the kinetic performance of the lithium-ion battery, allowing for reliability and fast charging performance.

In some embodiments of this application, a length of the long-range fiber is greater than 1 μm, and preferably, the length of the long-range fiber ranges from 1 μm to 1 mm, preferably 1 μm to 50 μm. The inventors have found that further increasing the length of long-range fiber brings no additional advantage. In addition, diameter of the long-range fiber is not limited in this application and may be, for example, 1 nm to 200 nm.

In some embodiments of this application, based on a total mass of the negative electrode active material layer, a mass percentage of the long-range fiber ranges from 0.2% to 1.5%. Without being limited to any theory, the inventors have found that when the percentage of the long-range fiber is excessively low (for example, less than 0.2%), the swelling of the negative electrode cannot be alleviated, and when the percentage of long-range conductive carbon is excessively high (for example, greater than 1.5%), the relative percentage of the active material in the negative electrode plate is reduced, affecting the energy density of the lithium-ion battery, and a great influence is brought on the kinetic performance of the negative electrode plate.

More fortuitously, the inventors have also found that increasing the active specific surface area of the negative electrode active material layer of the negative electrode plate in this application causes no problem of a thickened SEI (Solid Electrolyte Interphase, solid electrolyte interphase) film, and more importantly, the negative electrode active material layer in this application has reduced electrochemical reaction energy barrier, allowing for lower activation energy of the negative electrode plate. In some embodiments of this application, electrochemical reaction activation energy Ea of the negative electrode plate satisfies 25 kJ/mol≤Ea≤55 kJ/mol. The inventors have found that when the negative electrode active material contains no silicon, the negative electrode plate has lower electrochemical reaction activation energy, with Ea satisfying 25 kJ/mol≤Ea≤37 kJ/mol. The negative electrode plate in this application has lower activation energy than prior-art negative electrode plates, and this is more conducive to improving the kinetic performance of the lithium-ion battery.

In some embodiments of this application, the negative electrode active material layer further includes a conductive agent. The type of the conductive agent is not limited in this application and may include, for example, at least one selected from the group consisting of conductive carbon black, conductive graphite, graphene, and acetylene black. The conductive agent added can improve the conductivity of the negative electrode. The percentage of the conductive agent in the negative electrode active material layer is not particularly limited in this application, provided that the objectives of this application can be achieved. For example, the conductive agent accounts for 0% to 1% of the total mass of the negative electrode active material layer.

In some embodiments of this application, the negative electrode active material layer further includes a binder. The type of the binder is not limited in this application. For example, the binder may include at least one selected from the group consisting of polyvinylidene fluoride, a vinylidene fluoride-fluorinated olefin copolymer, polyvinylpyrrolidone, polyacrylonitrile, polymethyl acrylate, polytetrafluoroethylene, styrene-butadiene rubber, polyurethane, fluorinated rubber, and polyvinyl alcohol. The binder added can improve adhesion of the negative electrode active material layer, reduce the probability of fall-off of the negative electrode active material and the conductive agent from the negative electrode active material layer, and reduce the probability of fall-off of the negative electrode active material layer from a current collector. The percentage of the binder in the negative electrode active material layer is not particularly limited in this application, provided that the objectives of this application can be achieved. For example, the binder accounts for 0.5% to 10% of the total mass of the negative electrode active material layer.

The negative electrode plate in this application can be prepared by providing the negative electrode active material layer on a negative electrode current collector. The current collector is not particularly limited and may be a negative electrode current collector known in the art, such as copper foil, aluminum foil, aluminum alloy foil, or a composite current collector. In this application, thicknesses of the negative electrode current collector and the negative electrode active material layer are not particularly limited, provided that the objectives of this application can be achieved. For example, the thickness of the negative electrode current collector is 6 μm to m, and the thickness of the negative electrode active material layer is 30 μm to 120 μm.

A second aspect of this application provides a method of preparing the negative electrode plate according to the first aspect of this application. The method includes the following steps:
applying a slurry of a negative electrode active material layer onto at least one surface of a negative electrode current collector, followed by drying, to produce an initial electrode plate; and
performing a modification treatment on the initial electrode plate to obtain the negative electrode plate;
where the modification treatment includes at least one of a plasma treatment, a heat treatment, or a laser treatment.

Specifically, in some embodiments of this application, the plasma treatment may include: subjecting the initial electrode plate to plasma treatment in a vacuum environment, where the plasma treatment is conducted within a power range of 0.5 kW to 5 kW, a gas source includes at least one selected from the group consisting of nitrogen, argon, and carbon tetrafluoride, a gas flow rate is within a range of 200 mL/min to 3000 mL/min, a temperature is within a range of 20° C. to 60° C., and a treatment time is within a range of 1 min to 60 min.

In some embodiments of this application, the heat treatment may include: placing the initial electrode plate in a vacuum or inert gas environment for heat treatment for 1 min to 60 min at a temperature within a range of 200° C. to 350° C. A heating method is not limited in this application, provided that the objectives of this application can be achieved, for example, blast heating, infrared heating, microwave heating, or electromagnetic induction heating can be used.

In some embodiments of this application, the laser treatment may include: treating the initial electrode plate for 1 s to 600 s in a vacuum or inert gas environment, with a laser intensity of 30 W to 100 W. Specifically, the initial electrode plate can be placed within a working range of a laser emitter in the vacuum or inert gas environment for treatment for 1 s to 600 s, with a laser intensity of 30 W to 100 W and a distance of 3 cm to 10 cm between a laser source and the initial electrode plate.

In this application, the initial electrode plate can be prepared using conventional methods in the art. The foregoing description of the negative electrode plate is applicable to constituents and percentages of the negative electrode active material layer. The inventors have found that the initial electrode plate can be subjected to modification treatment under a specified condition to obtain the negative electrode plate in this application.

A third aspect of this application provides an electrochemical apparatus including the negative electrode plate according to the first aspect of this application, while other components including a positive electrode plate, a separator, an electrolyte, and the like are not particularly limited, provided that the objectives of this application can be achieved.

For example, the positive electrode plate typically includes a positive electrode current collector and a positive electrode active material layer. The positive electrode current collector is not particularly limited and may be a positive electrode current collector known in the art, such as copper foil, aluminum foil, aluminum alloy foil, or a composite current collector. The positive electrode active material layer includes a positive electrode active material. The positive electrode active material is not particularly limited and may be a positive electrode active material known in the art. For example, the positive electrode active material includes at least one selected from the group consisting of lithium nickel cobalt manganate (811, 622, 523, 111), lithium nickel cobalt aluminate, lithium iron phosphate, a lithium-rich manganese-based material, lithium cobaltate, lithium manganate, lithium iron manganese phosphate, and lithium titanate. In this application, thicknesses of the positive electrode current collector and the positive electrode active material layer are not particularly limited, provided that the objectives of this application can be achieved. For example, the thickness of the positive electrode current collector is 8 μm to 12 μm, and the thickness of the positive electrode active material layer is 30 μm to 120 μm.

Optionally, the positive electrode plate may further include a conductive layer, and the conductive layer is sandwiched between the positive electrode current collector and the positive electrode active material layer. Composition of the conductive layer is not particularly limited, and the conductive layer may be a conductive layer commonly used in the art. The conductive layer includes a conductive agent and a binder. The conductive agent is not particularly limited and may be any conductive agent well known to persons skilled in the art or a combination thereof. For example, the conductive agent may be at least one selected from the group consisting of a zero-dimensional conductive agent, a one-dimensional conductive agent, and a two-dimensional conductive agent. Preferably, the conductive agent may include at least one selected from the group consisting of carbon black, conductive graphite, carbon fiber, carbon nanotubes, VGCF (Vapor-Grown Carbon Nanofiber), and graphene. The amount of the conductive agent is not particularly limited and can be selected according to common knowledge well known in the art. One type of the foregoing conductive agents may be used alone, or two or more types may be used in combination in any proportion.

The binder in the conductive layer is not particularly limited and may be any binder known to persons skilled in the art or a combination thereof. For example, the binder may be at least one selected from the group consisting of polyacrylate ester, polyimide, polyamide, polyamideimide, polyvinylidene fluoride, styrene-butadiene rubber, sodium alginate, polyvinyl alcohol, polytetrafluoroethylene, polyacrylonitrile, sodium carboxymethyl cellulose, and lithium carboxymethyl cellulose. One type of these binders may be used alone, or two or more types may be used in combination in any proportion.

The electrochemical apparatus in this application further includes a separator, where the separator is used to separate a positive electrode from a negative electrode, prevent short circuit in the electrochemical apparatus, and allow electrolyte ions to freely pass through to complete an electrochemical charging and discharging process. The separator is not particularly limited in this application, provided that the objectives of this application can be achieved.

For example, the separator may be at least one of a polyethylene (PE) and polypropylene (PP)-based polyolefin (PO) separator, a polyester film (for example, a polyethylene terephthalate (PET) film), a cellulose film, a polyimide film (PI), a polyamide film (PA), a spandex or aramid film, a woven film, a non-woven film (non-woven fabric), a microporous film, a composite film, a separator paper, a laminated film, a spinning film, or the like.

For example, the separator may include a substrate layer and a surface treatment layer. The substrate layer may be a non-woven fabric, film, or composite film of a porous structure. A material of the substrate layer may include at least one of polyethylene, polypropylene, polyethylene terephthalate, polyimide, or the like. Optionally, a polypropylene porous film, a polyethylene porous film, polypropylene non-woven fabric, a polyethylene non-woven fabric, or a polypropylene-polyethylene-polypropylene porous composite film may be used. Optionally, the surface treatment layer is provided on at least one surface of the substrate layer, and the surface treatment layer may be a polymer layer or an inorganic substance layer, or a layer formed by a mixture of a polymer and an inorganic substance.

For example, the inorganic substance layer includes inorganic particles and a binder. The inorganic particles are not particularly limited. For example, the inorganic particles may be at least one selected from aluminum oxide, silicon oxide, magnesium oxide, titanium oxide, hafnium dioxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, barium sulfate, and the like. The binder is not particularly limited. For example, the binder may be one or a combination of several selected from polyvinylidene fluoride, a vinylidene fluoride-hexafluoropropylene copolymer, polyamide, polyacrylonitrile, polyacrylate ester, polyacrylic acid, polyacrylate salt, polyvinylpyrrolidone, polyvinyl ether, polymethyl methacrylate, polytetrafluoroethylene, and polyhexafluoropropylene. The polymer layer contains a polymer, and a material of the polymer includes at least one of polyamide, polyacrylonitrile, an acrylate polymer, polyacrylic acid, polyacrylate salt, polyvinylpyrrolidone, polyvinyl ether, polyvinylidene fluoride, poly(vinylidene fluoride-hexafluoropropylene), or the like.

The electrochemical apparatus in this application further includes an electrolyte. The electrolyte may be one or more of a gel electrolyte, a solid electrolyte, and a liquid electrolyte, where the liquid electrolyte includes a lithium salt and a non-aqueous solvent.

In some embodiments of the first aspect of this application, the lithium salt is one or more selected from lithium hexafluorophosphate (LiPF₆), lithium tetrafluoroborate (LiBF₄), lithium hexafluoroarsenate (LiAsF₆), lithium perchlorate (LiClO₄), lithium tetraphenylboride (LiB(C₆H₅)₄), lithium methanesulfonate (LiCH₃SO₃), lithium triflate (LiCF₃SO₃), lithium bistrifluoromethanesulfonimide (LiN(SO₂CF₃)₂), LiC(SO₂CF₃)₃, lithium fluosilicate (LiSiF₆), lithium bisoxalate borate (LiBOB), and lithium difluoroborate (LiF₂OB). For example, LiPF₆ may be selected as the lithium salt because it can provide high ionic conductivity and improve cycling performance.

The non-aqueous solvent may be a carbonate compound, a carboxylate compound, an ether compound, another organic solvent, or a combination thereof.

The carbonate compound may be a linear carbonate compound, a cyclic carbonate compound, a fluorocarbonate compound, or a combination thereof.

An example of the linear carbonate compound is dimethyl carbonate (DMC), diethyl carbonate (DEC), dipropyl carbonate (DPC), methyl propyl carbonate (MPC), ethylene propyl carbonate (EPC), ethyl methyl carbonate (EMC), or a combination thereof. An example of the cyclic carbonate compound is ethylene carbonate (EC), propylene carbonate (PC), butylene carbonate (BC), vinyl ethylene carbonate (VEC), or a combination thereof. An example of the fluorocarbonate compound is fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

An example of the carboxylate compound is methyl formate, methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, or a combination thereof.

An example of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, or a combination thereof.

An example of the another organic solvent is dimethyl sulfoxide, 1,2-dioxolane, sulfolane, methyl sulfolane, 1,3-dimethyl-2-imidazolidinone, N-methyl-2-pyrrolidone, methylamide, dimethylformamide, acetonitrile, trimethyl phosphate, triethyl phosphate, trioctyl phosphate, phosphate ester, or a combination thereof.

A process for preparing the electrochemical apparatus is well known to persons skilled in the art and is not particularly limited in this application. For example, the electrochemical apparatus may be manufactured in the following procedure: a positive electrode and a negative electrode are stacked with a separator therebetween, and the resulting stack is put into a housing after subjected to operations such as winding and folding as needed. The housing is injected with an electrolyte and then sealed. In addition, an overcurrent prevention element, a guide plate, and the like may also be placed in the housing as needed, so as to prevent pressure increase, overcharge, and overdischarge in the electrochemical apparatus.

A fourth aspect of this application provides an electronic device including the electrochemical apparatus according to the third aspect of this application.

The electronic device in this application is not particularly limited and may be any known electronic device used in the prior art. In some embodiments, the electronic device may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a motor bicycle, a bicycle, a lighting appliance, a toy, a game console, a timepiece, an electric tool, a flash lamp, a camera, a large household battery, and a lithium-ion capacitor.

In the electrochemical apparatus and electronic device provided in this application, the temperature corresponding to the peak height of the first peak on the DTG curve of the negative electrode plate is higher than 350° C., and the active specific surface area of the negative electrode active material layer is greater than or equal to K·25 cm²/g. The electrochemical apparatus using the negative electrode plate in this application has better kinetic performance, an increased lithium precipitation window, and a faster charging speed.

### BRIEF DESCRIPTION OF DRAWINGS

To describe the technical solutions in embodiments of this application and in the prior art more clearly, the following briefly describes the accompanying drawings required for describing these embodiments and the prior art. Apparently, the accompanying drawings in the following description show only an embodiment of this application, and persons of ordinary skill in the art may still derive other drawings from these accompanying drawings.

FIG. 1 shows a TG curve and DTG curve of a negative electrode plate in Example 1.

FIG. 2 shows a TG curve and DTG curve of a negative electrode plate in Example 7.

FIG. 3 shows a TG curve and DTG curve of a negative electrode plate in Comparative Example 2.

### DETAILED DESCRIPTION

To make the objectives, technical solutions, and advantages of this application clearer, the following further describes this application in detail with reference to the accompanying drawings and some embodiments. Apparently, the described embodiments are only some but not all of these embodiments of this application. All other technical solutions obtained by persons of ordinary skill in the art based on these embodiments of this application shall fall within the protection scope of this application.

It should be noted that, in specific embodiments of this application, an example in which a lithium-ion battery is used as an electrochemical apparatus is used to illustrate this application. However, the electrochemical apparatus in this application is not limited to the lithium-ion battery.

### Test Method

### TG Test

The negative electrode plate in each of the examples and comparative examples was taken and cut into small discs with a diameter D of 14 mm, and then was subjected to TG test in a nitrogen atmosphere, with a test temperature rising from 25° C. to 600° C. at a temperature rise velocity of 10° C./min. For a TG curve obtained, derivative treatment was performed on the TG curve to obtain a DTG curve which could indicate a weight loss peak temperature and weight loss velocity of the negative electrode plate.

### Active Specific Surface Area Test

The negative electrode plate in each of the examples and comparative examples was cut into discs with a diameter of 1.4 cm in a dry environment by using a punching machine, and the mass was recorded as m. In a glove box, a button cell was assembled with a lithium metal plate as a counter electrode, a ceglard composite membrane as a separator, and an electrolyte added, where the electrolyte contained an electrochemical redox probe molecule ferrocene with a concentration of c.

A series of cyclic voltammetry curves were obtained by testing with an electrochemical workstation at different scan velocities v, and peak currents Ip were obtained from the cyclic voltammetry curves; and a series of peak currents Ip obtained and square roots of scan velocities v were plotted to obtain a slope K. According to the Randles-Sevick equation, the active surface area A of the electrode plate was equal to K/(2.69×10⁵n^{3/2}c\sqrt{D}), where n represented an electron transfer number of electrode reaction and was 1 in this test system; c represents the concentration of the probe molecule; D represents a diffusion coefficient of the probe molecule, and the diffusion coefficient of ferrocene in this system was 2.1×10⁻⁶ cm²/s; and a ratio of the active surface area A of the electrode plate to a mass (m: mass of the current collector) of the active material layer of the electrode plate was the active specific surface area of the active material layer.

### Activation Energy Test

Two negative electrode plates prepared in each of the examples and comparative examples were taken, a separator was sandwiched between the two negative electrode plates, sealing was performed, then an electrolyte was injected, to obtain a symmetric cell. An electrochemical impedance spectrum (EIS) of the symmetric cell was tested at different temperatures, and Rct (electrochemical reaction impedance) of the cell was obtained. The activation energy was calculated according to Arrhenius formula.

### Polarization Impedance Test

The negative electrode plate in each of the examples and comparative examples and a same positive electrode plate were used for the assembly of a lithium-ion battery, separately. The obtained lithium-ion battery was installed on a charging and discharging device for charging and discharging, and voltage and current of the lithium-ion battery were monitored to obtain a direct current impedance value of the lithium-ion battery. Specifically, the lithium-ion battery was charged to a full-charge voltage at a constant current of 0.5 C, and then charged to 0.05 C at a constant voltage. Then the lithium-ion battery was discharged for 30 min at a current of 1 C to be in a 50% state of charge, and was then left standing for 60 min. The lithium-ion battery was discharged for 10 s at a current of 0.1 C, and a voltage was recorded as V1. Then the lithium-ion battery was discharged for 1 s at a current of 1 C, and a voltage was recorded as V2. The polarization impedance 1 s DCR of the lithium-ion battery was calculated according to the following formula:

1 s DCR=(V1−V2)/(1 C−0.1 C).

### Charging Speed Test

The negative electrode plate in each of the examples and comparative examples were used for the assembly of a lithium-ion battery, respectively. The obtained lithium-ion battery was left standing for 30 minutes in an environment at 25° C., charged to a rated voltage at a constant current of 0.5 C, and then charged at a constant voltage until the charge and discharge rate reached 0.05 C. A time from a point at which charging was started to a point at which charging was stopped was a full-charge time.

### Lithium Precipitation Window Test

The electrochemical apparatus was first discharged to a fully discharged state, then a specified temperature (for example, 25° C.) was set, and the electrochemical apparatus was conventionally charged (constant current+constant voltage) at different rates such as 1 C, 1.1 C, 1.2 C, . . . , based on designs, that is, charged to a rated voltage of the battery at specified rates, then charged to 0.05 C at a constant voltage, and then fully discharged at 0.2 C. Such charging and discharging process was repeated for 10 cycles. Finally, the fully charged electrochemical apparatus was disassembled to check whether lithium precipitation occurred at the negative electrode plate. A maximum current without lithium precipitation (no white spot was present on the surface of the negative electrode plate) was defined as a maximum rate without lithium precipitation of the battery, that is, a lithium precipitation window.

### Cycling Performance Test

The negative electrode plates prepared in the examples and comparative examples were used for the assembly of full cells. At a test temperature of 45° C., the full cell was charged to a rated voltage at a constant current of 0.5 C, charged to 0.025 C at a constant voltage, left standing for 5 minutes, and then discharged to 3.0 V at 0.5 C. A capacity obtained in this cycle was an initial capacity. Then a 0.5 C charge and 0.5 C discharge cycling test was performed. A ratio of the capacity of each cycle to the initial capacity was calculated to obtain a capacity attenuation curve. Capacity retention rates after 300 cycles for the examples and comparative examples were as shown in Table 1.

### Full-Charge Swelling Rate Test

A PPG pouch cell thickness gauge (with a specified pressure controlled to, for example, 400 g) was used to measure a thickness of the lithium-ion battery at initial half charge (the battery was charged until the capacity reached half of a capacity in a fully charged state). At 45° C., after 300 charge and discharge cycles, the lithium-ion battery was in the fully charged state, and a thickness of the lithium-ion battery at that point was measured with the PPG pouch cell thickness gauge. The measured thickness was compared with the thickness of the lithium-ion battery at the initial half charge to obtain a swelling rate of the fully charged lithium-ion battery at that point.

### Preparation of Full Cell

### Preparation of Positive Electrode Plate

A positive electrode active material lithium cobaltate, a conductive agent conductive carbon black, and a binder polyvinylidene fluoride (PVDF) at a weight ratio of 97.6:1.1:1.3 were dissolved in an N-methylpyrrolidone (NMP) solution to form a positive electrode slurry with a solid content of 75%. A 10 μm thick aluminum foil was used as a positive electrode current collector. The positive electrode slurry was applied on the positive electrode current collector, with a coating thickness of 50 μm, followed by drying to obtain a positive electrode plate with the coating applied on one surface. Then the above steps were repeated on the other surface of the positive electrode plate to obtain a positive electrode plate with the positive electrode active material applied on two surfaces.

### Preparation of Separator

Polyethylene (PE) with a thickness of 8 μm was used as a separator substrate, two sides of the separator substrate were each coated with a 2 μm aluminum oxide ceramic layer, and then the two sides coated with the ceramic layers were each coated with a binder polyvinylidene fluoride (PVDF), with a coating weight of 2.5 mg, followed by drying.

### Preparation of Electrolyte

In an environment with a moisture content less than 10 ppm, lithium hexafluorophosphate (LiPF₆) and non-aqueous organic solvents (ethylene carbonate (EC):propylene carbonate (PC):polypropylene (PP):diethyl carbonate (DEC)=1:1:1:1 by weight) were used to prepare an electrolyte with a concentration of LiPF₆ being 1.15 mol/L.

### Assembly of Full Cell

The positive electrode plate, the separator, and the negative electrode plate prepared in each of the examples and comparative examples were stacked in order, so that the separator was sandwiched between the positive and negative electrodes for separation. Then winding was performed to obtain an electrode assembly. The electrode assembly was placed in an outer packaging aluminum-plastic film, and was dehydrated at 80° C. Then the electrolyte was injected and packaging was performed, followed by processes such as formation, degassing, and trimming to obtain a lithium-ion battery.

### Preparation of Negative Electrode Plate

### Example 1

A negative electrode active material artificial graphite (Dᵥ50=15 μm), a dispersant lithium carboxymethyl cellulose, and a binder styrene-butadiene rubber at a weight ratio of 98:1:1 were dissolved in deionized water to form a negative electrode slurry with a solid content of 70%. A 10 μm thick copper foil was used as a negative electrode current collector. The negative electrode slurry was applied on the negative electrode current collector, with a coating thickness of 80 μm, followed by drying to obtain a negative electrode plate with the coating applied on one surface. Then the above steps were repeated on the other surface of the negative electrode plate to obtain a negative electrode plate with the negative electrode active material applied on two surfaces. The electrode plate was first cold-pressed and then heated for 1 h at 300° C. in the nitrogen (N₂) atmosphere to obtain a treated negative electrode plate.

### Example 2

This example was the same as Example 1 except that the heating temperature was adjusted to 200° C.

### Example 3

This example was the same as Example 1 except that the heating temperature was adjusted to 350° C.

### Example 4

This example was the same as Example 1 except that Dᵥ50 of artificial graphite was 20 m.

### Example 5

This example was the same as Example 1 except that Dᵥ50 of artificial graphite was 25 m.

### Example 6

This example was the same as Example 1 except that the nitrogen atmosphere was adjusted to a vacuum atmosphere with a vacuum degree of 5000 Pa.

### Example 7

This example was the same as Example 1 except that after the electrode plate was cold-pressed, the electrode plate was placed in vacuum and subjected to plasma treatment, with a plasma power of 2.5 kW, a gas source being carbon tetrafluoride, a gas flow rate of 2000 mL/min, a temperature of 30° C., and a treatment time of 30 min, to obtain the treated negative electrode plate.

### Example 8

This example was the same as Example 1 except that after the electrode plate was cold-pressed, the electrode plate was placed in vacuum and subjected to plasma treatment, with a plasma power of 0.5 kW, a gas source being argon, a gas flow rate of 200 mL/min, a temperature of 20° C., and a treatment time of 60 min, to obtain the treated negative electrode plate.

### Example 9

This example was the same as Example 1 except that after the electrode plate was cold-pressed, the electrode plate was placed in vacuum and subjected to plasma treatment, with a plasma power of 5 kW, a gas source being nitrogen, a gas flow rate of 2000 mL/min, a temperature of 60° C., and a treatment time of 5 min, to obtain the treated negative electrode plate.

### Example 10

This example was the same as Example 1 except that after the electrode plate was cold-pressed, the electrode plate was placed within a working range of a laser emitter in the N₂ atmosphere for treatment for 500 s, with a laser intensity of 40 W and a distance of 7 cm between a laser source and the electrode plate, to obtain the treated negative electrode plate.

### Example 11

This example was the same as Example 10 except that the laser intensity was adjusted to 80 W and the treatment time was adjusted to 100 s.

### Example 12

This example was the same as Example 10 except that the laser intensity was adjusted to 100 W and the treatment time was adjusted to 20 s.

### Example 13

This example was the same as Example 1 except that Dᵥ50 of the negative electrode active material (artificial graphite) was adjusted from 15 μm to 10 μm.

### Example 14

This example was the same as Example 1 except that Dᵥ50 of the negative electrode active material (artificial graphite) was adjusted from 15 μm to 30 μm.

### Example 15

This example was the same as Example 1 except that the composition (weight percentage) of the negative electrode slurry was adjusted to 88% silicon oxide (Dᵥ50=10 μm, G1S-C450)+2% lithium carboxymethyl cellulose+10% styrene-butadiene rubber.

### Example 16

This example was the same as Example 1 except that the negative electrode active material was adjusted from artificial graphite to hard carbon (Dᵥ50=10 μm, MS-BHC-400).

### Example 17

This example was the same as Example 1 except that the composition (weight percentage) of the negative electrode slurry was adjusted to 89.4% silicon-carbon material (Dᵥ50=10 μm, SN-SC2)+1% lithium carboxymethyl cellulose+9.6% styrene-butadiene rubber.

### Comparative Example 1

This comparative example was the same as Example 1 except that the negative electrode plate was not subjected to heat treatment after cold-pressed, to directly obtain the negative electrode plate.

### Comparative Example 2

This comparative example was the same as Example 1 except that the heating temperature of the negative electrode plate was adjusted to 150° C.

### Comparative Example 3

This comparative example was the same as Example 1 except that the nitrogen atmosphere was replaced with an air atmosphere.

### Comparative Example 4

This comparative example was the same as Example 1 except that the heating temperature of the negative electrode plate was adjusted to 400° C.

### Comparative Example 5

This comparative example was the same as Example 13 except that the negative electrode plate was not subjected to heat treatment after cold-pressed, to directly obtain the negative electrode plate.

### Comparative Example 6

This comparative example was the same as Example 15 except that the negative electrode plate was not subjected to heat treatment after cold-pressed, to directly obtain the negative electrode plate.

### Comparative Example 7

This comparative example was the same as Example 16 except that the negative electrode plate was not subjected to heat treatment after cold-pressed, to directly obtain the negative electrode plate.

### Comparative Example 8

This comparative example was the same as Example 17 except that the negative electrode plate was not subjected to heat treatment after cold-pressed, to directly obtain the negative electrode plate.

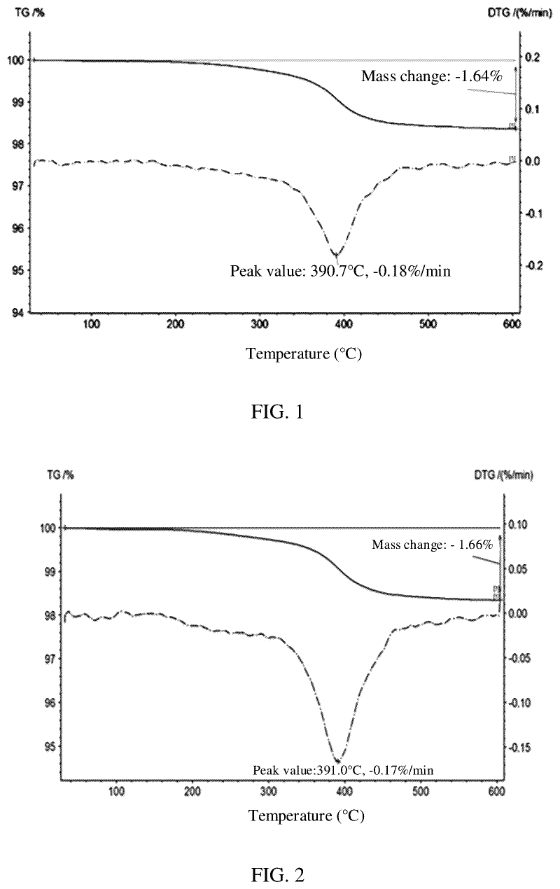

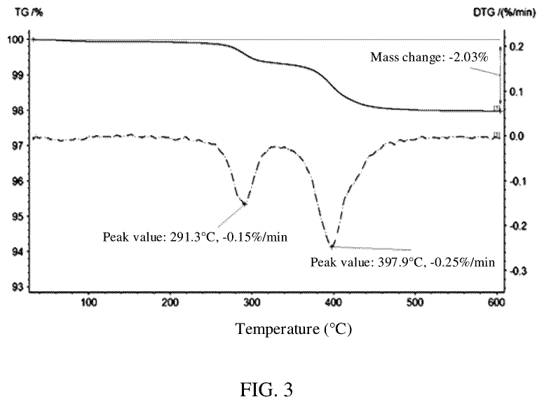

The TG and DTG curves of the negative electrode plate obtained in Example 1 were as shown in FIG. 1. The TG and DTG curves of the negative electrode plate obtained in Example 7 were as shown in FIG. 2. The peak heights position of the first peaks on the two curves both only appeared about 400° C. The TG and DTG curves of the negative electrode plate obtained in Comparative Example 2 were shown in FIG. 3, with the peak heights of the first peaks appeared in a range of 250° C. to 350° C. and the peak heights of the second peaks appeared about 400° C.

TABLE 1

| | | | Peak | | | | | | | | |
|---|---|---|---|---|---|---|---|---|---|---|---|
| | | | height | | | | | | Charging | | |
| | Negative | | position | | | Active | | Polarization | speed | | Cycling |
| | electrode | | of first | Negative | | specific | | impedance | (full- | Lithium | capacity |
| | active | | peak of | electrode | Heat | surface | Activation | (25° C. 1 s | charge | precipitation | retention |
| | material | K · 25 | DTG | active | treatment | area | energy | DCR | time | window | rate after |
| | (Dᵥ50) | (cm²/g) | curve | material | condition | (cm²/g) | (kJ/mol) | (mohm)) | (min)) | (25° C.) | 300 cycles |
| Example 1 | 15 | 25 | Higher than | Artificial | N₂ | 28 | 30 | 36 | 61 | No lithium | 94% |
| | | | 350° C. | graphite | 300° C. | | | | | precipitation at | |
| | | | | | | | | | | 2.8 C | |
| Example 2 | 15 | 25 | Higher than | Artificial | N₂ | 28 | 30 | 36 | 61 | No lithium | 94% |
| | | | 350° C. | graphite | 200° C. | | | | | precipitation at | |
| | | | | | | | | | | 2.8 C | |
| Example 3 | 15 | 25 | Higher than | Artificial | N₂ | 28 | 30 | 36 | 61 | No lithium | 94% |
| | | | 350° C. | graphite | 350° C. | | | | | precipitation at | |
| | | | | | | | | | | 2.8 C | |
| Example 4 | 20 | 18.75 | Higher than | Artificial | N₂ | 20 | 32 | 40 | 63 | No lithium | 93% |
| | | | 350° C. | graphite | 300° C. | | | | | precipitation at | |
| | | | | | | | | | | 2.6 C | |
| Example 5 | 25 | 15 | Higher than | Artificial | N₂ | 18 | 33 | 44 | 66 | No lithium | 91% |
| | | | 350° C. | graphite | 300° C. | | | | | precipitation at | |
| | | | | | | | | | | 2.3 C | |
| Example 6 | 15 | 25 | Higher than | Artificial | Vacuum | 28 | 30 | 36 | 61 | No lithium | 94% |
| | | | 350° C. | graphite | 300° C. | | | | | precipitation at | |
| | | | | | | | | | | 2.8 C | |
| Example 7 | 15 | 25 | Higher than | Artificial | Vacuum | 28 | 30 | 36 | 61 | No lithium | 94% |
| | | | 350° C. | graphite | plasma | | | | | precipitation at | |
| | | | | | 30° C. | | | | | 2.8 C | |
| Example 8 | 15 | 25 | Higher than | Artificial | Vacuum | 28 | 30 | 36 | 61 | No lithium | 94% |
| | | | 350° C. | graphite | plasma | | | | | precipitation at | |
| | | | | | 20° C. | | | | | 2.8 C | |
| Example 9 | 15 | 25 | Higher than | Artificial | Vacuum | 28 | 30 | 36 | 61 | No lithium | 94% |
| | | | 350° C. | graphite | plasma | | | | | precipitation at | |
| | | | | | 60° C. | | | | | 2.8 C | |
| Example 10 | 15 | 25 | Higher than | Artificial | Laser | 28 | 30 | 36 | 61 | No lithium | 94% |
| | | | 350° C. | graphite | 40 W | | | | | precipitation at | |
| | | | | | 500 s | | | | | 2.8 C | |
| Example 11 | 15 | 25 | Higher than | Artificial | Laser | 28 | 30 | 36 | 61 | No lithium | 94% |
| | | | 350° C. | graphite | 80 W | | | | | precipitation at | |
| | | | | | 100 s | | | | | 2.8 C | |
| Example 12 | 15 | 25 | Higher than | Artificial | Laser | 28 | 30 | 36 | 61 | No lithium | 94% |
| | | | 350° C. | graphite | 100 W | | | | | precipitation at | |
| | | | | | 20 s | | | | | 2.8 C | |
| Example 13 | 10 | 37.5 | Higher than | Artificial | N₂ | 39 | 29 | 30 | 57 | No lithium | 92% |
| | | | 350° C. | graphite | 300° C. | | | | | precipitation at | |
| | | | | | | | | | | 3.0 C | |
| Example 14 | 30 | 12.5 | Higher than | Artificial | N₂ | 15 | 35 | 47 | 69 | No lithium | 90% |
| | | | 350° C. | graphite | 300° C. | | | | | precipitation at | |
| | | | | | | | | | | 2.0 C | |
| Example 15 | 10 | 37.5 | Higher than | Silicon | N₂ | 40 | 50 | 55 | 79 | No lithium | 88% |
| | | | 350° C. | oxide | 300° C. | | | | | precipitation at | |
| | | | | | | | | | | 1.5 C | |
| Example 16 | 10 | 37.5 | Higher than | Hard | N₂ | 40 | 29 | 28 | 55 | No lithium | 90% |
| | | | 350° C. | carbon | 300° C. | | | | | precipitation at | |
| | | | | | | | | | | 3.0 C | |
| Example 17 | 10 | 37.5 | Higher than | Silicon | N₂ | 41 | 48 | 52 | 76 | No lithium | 87% |
| | | | 350° C. | carbon | 300° C. | | | | | precipitation at | |
| | | | | | | | | | | 1.7 C | |
| Comparative | 15 | 25 | between | Artificial | No | 22 | 41 | 45 | 68 | No lithium | 94% |
| Example 1 | | | 250° C. and | graphite | treatment | | | | | precipitation at | |
| | | | 350° C. | | | | | | | 1.8 C | |
| Comparative | 15 | 25 | between | Artificial | N₂ | 22 | 41 | 45 | 68 | No lithium | 94% |
| Example 2 | | | 250° C. and | graphite | 150° C. | | | | | precipitation at | |
| | | | 350° C. | | | | | | | 1.8 C | |
| Comparative | 15 | 25 | No peak | Artificial | Air | / | / | / | / | / | |
| Example 3 | | | (serious | graphite | 300° C. | | | | | | |
| | | | fall-off of | | | | | | | | |
| | | | coating, | | | | | | | | |
| | | | incapability | | | | | | | | |
| | | | of being | | | | | | | | |
| | | | prepared | | | | | | | | |
| | | | into battery | | | | | | | | |
| | | | for analysis) | | | | | | | | |
| Comparative | 15 | 25 | No peak | Artificial | N₂ | / | / | / | / | / | / |
| Example 4 | | | (serious | graphite | 400° C. | | | | | | |
| | | | fall-off of | | | | | | | | |
| | | | coating, | | | | | | | | |
| | | | incapability | | | | | | | | |
| | | | of being | | | | | | | | |
| | | | prepared | | | | | | | | |
| | | | into battery | | | | | | | | |
| | | | for analysis) | | | | | | | | |
| Comparative | 10 | 37.5 | between | Artificial | No | 30 | 40 | 41 | 65 | No lithium | 92% |
| Example 5 | | | 250° C. and | graphite | treatment | | | | | precipitation at | |
| | | | 350° C. | | | | | | | 2.0 C | |
| Comparative | 10 | 37.5 | between | Silicon | No | 32 | 60 | 67 | 88 | No lithium | 88% |
| Example 6 | | | 250° C. and | oxide | treatment | | | | | precipitation at | |
| | | | 350° C. | | | | | | | 0.7 C | |
| Comparative | 10 | 37.5 | between | Hard | No | 29 | 40 | 40 | 63 | No lithium | 90% |
| Example 7 | | | 250° C. and | carbon | treatment | | | | | precipitation at | |
| | | | 350° C. | | | | | | | 2.0 C | |
| Comparative | 10 | 37.5 | between | Silicon | No | 30 | 58 | 66 | 87 | No lithium | 87% |
| Example 8 | | | 250° C. and | carbon | treatment | | | | | precipitation at | |
| | | | 350° C. | | | | | | | 0.8 C | |

It can be learned from the comparisons between Examples 1 to 12 and Comparative Examples 1 to 8 that the negative electrode plate has significantly improved kinetic performance and electrochemical performance after a specified modification treatment, where as compared with Comparative Example 1, in Examples 1 to 3 and 6 to 12, the active specific surface area of the negative electrode active material layer is increased by about 27%, the activation energy of the electrode plate is reduced by 27%, the polarization impedance is reduced by about 20%, the lithium precipitation window is increased by about 1 C (rate), the charging speed is increased by about 10%, and the cycling capacity retention rate after 300 cycles has no significant change as compared with that without heat treatment. This indicates that the kinetic performance of the electrochemical apparatus including the negative electrode plate of this application is significantly improved, with no significant influence on the cycling performance. It can also be learned from Examples 1 to 3 and 6 to 12 that the negative electrode plate of this application can be obtained using different heating methods of this application.

However, the active specific surface areas of the negative electrode active material layers obtained without modification treatment or with the modification treatment condition different from that in this application (for example, Comparative Examples 1 to 8) are all lower than that of the negative electrode active material layer of this application, so that the kinetic performance and electrochemical performance of the negative electrode plates are both lower than that of the negative electrode plate of this application. This indicates that after the negative electrode plate is subjected to modification treatment using the method of this application, the negative electrode plate has significantly improved kinetic performance and electrochemical performance. Without being limited to any theory, the inventors have believed that this is because the active specific surface area of the active material layer of the electrode plate after heat treatment is increased such that more active sites are exposed.

The inventors have also found that heating is performed in the air atmosphere in Comparative Example 3, heating is performed at 400° C. in the nitrogen atmosphere in Comparative Example 4, and the negative electrode plate obtained after heating has serious fall-off of coating, cannot satisfy the processability, cannot be used for preparing the lithium-ion battery, and thus has no “active specific surface area” described above.

It can be learned from comparison between Examples 13 to 17 and Comparative Examples 5 to 8 that the active material layers of the negative electrode plates prepared through treatment on same or different types of negative electrode active materials with different particle sizes by the method of this application can all have higher active specific surface areas, and the negative electrode plates obtained have better kinetic performance and electrochemical performance. For different negative electrode active materials, compared with the negative electrode plates subjected to no modification treatment, the negative electrode plates have significantly improved kinetic performance and electrochemical performance after modification treatment.

### Example 18

This example was the same as Example 1 except that the composition (weight percentage) of the negative electrode slurry was adjusted to 97.5% artificial graphite+1% lithium carboxymethyl cellulose+1% styrene-butadiene rubber+0.5% carbon nanotubes (CNT, with a length of 4 μm and a tube diameter of 5 nm).

### Example 19

This example was the same as Example 18 except that the CNT in the material was replaced with carbon nanofiber (VGCF, with a length of about 10 μm and a diameter of 10 nm).

### Example 20

This example was the same as Example 18 except that the composition (weight percentage) of the negative electrode slurry was adjusted to 96.5% artificial graphite+1% lithium carboxymethyl cellulose+1% styrene-butadiene rubber+1.5% carbon nanotubes (CNT, with a length of 4 μm and a tube diameter of 5 nm).

### Example 21

This example was the same as Example 18 except that the composition (weight percentage) of the negative electrode slurry was adjusted to 97% artificial graphite+1% lithium carboxymethyl cellulose+1% styrene-butadiene rubber+0.5% carbon nanotubes (CNT, with a length of 4 μm and a tube diameter of 5 nm)+0.5% carbon nanofiber (VGCF, with a length of about 10 μm and a diameter of 10 nm).

### Example 22

This example was the same as Example 18 except that the CNT in the material was replaced with long-range ceramic fiber (with a length of about 20 μm and a diameter of 10 nm).

### Example 23

This example was the same as Example 18 except that the CNT in the material was replaced with long-range aramid fiber (with a length of about 30 μm and a diameter of 10 nm).

### Comparative Example 9

This comparative example was the same as Example 18 except that the negative electrode plate was not subjected to heat treatment after cold-pressed, to directly obtain the negative electrode plate.

### Comparative Example 10

This comparative example was the same as Example 19 except that the negative electrode plate was not subjected to heat treatment after cold-pressed, to directly obtain the negative electrode plate.

### Comparative Example 11

This comparative example was the same as Example 20 except that the negative electrode plate was not subjected to heat treatment after cold-pressed, to directly obtain the negative electrode plate.

### Comparative Example 12

This comparative example was the same as Example 21 except that the negative electrode plate was not subjected to heat treatment after cold-pressed, to directly obtain the negative electrode plate.

### Comparative Example 13

This comparative example was the same as Example 22 except that the negative electrode plate was not subjected to heat treatment after cold-pressed, to directly obtain the negative electrode plate.

### Comparative Example 14

This comparative example was the same as Example 23 except that the negative electrode plate was not subjected to heat treatment after cold-pressed, to directly obtain the negative electrode plate.

TABLE 2

| | Peak | | | | | | | | | | |
|---|---|---|---|---|---|---|---|---|---|---|---|
| | height | | | | | | Polari- | Charging | | Cycling | Cycling |
| | position | | | | Active | | zation | speed | Lithium | capacity | swelling |
| | of first | Negative | | | specific | Acti- | impedance | (full- | precip- | retention | rate |
| | peak of | electrode | Long- | Heat | surface | vation | (25° C. | charge | itation | rate after | (after |
| | DTG | active | range | treatment | area | energy | 1 s DCR | time | window | 300 | 300 cycles |
| | curve | material | fiber | condition | (cm²/g) | (kJ/mol) | (mohm)) | (min)) | (25° C.) | cycles | at 45° C.) |
| Example 1 | Higher than | Artificial | — | N₂ 300° C. | 28 | 30 | 36 | 61 | No lithium | 94% | 7.60% |
| | 350° C. | graphite | | | | | | | precipitation | | |
| | | | | | | | | | at 2.8 C | | |
| Example 18 | Higher than | Artificial | 0.5% CNT | N₂ 300° C. | 30 | 28 | 38 | 60 | No lithium | 92% | 6.50% |
| | 350° C. | graphite | | | | | | | precipitation | | |
| | | | | | | | | | at 2.5 C | | |
| Example 19 | Higher than | Artificial | 0.5% | N₂ 300° C. | 31 | 27 | 37 | 60 | No lithium | 90% | 6.20% |
| | 350° C. | graphite | VGCF | | | | | | precipitation | | |
| | | | | | | | | | at 2.5 C | | |
| Example 20 | Higher than | Artificial | 1.5% CNT | N₂ 300° C. | 32 | 27 | 36 | 60 | No lithium | 90% | 6.00% |
| | 350° C. | graphite | | | | | | | precipitation | | |
| | | | | | | | | | at 2.4 C | | |
| Example 21 | Higher than | Artificial | 0.5% | N₂ 300° C. | 32 | 27 | 36 | 60 | No lithium | 90% | 6.10% |
| | 350° C. | graphite | CNT + 0.5% | | | | | | precipitation | | |
| | | | VGCF | | | | | | at 2.5 C | | |
| Example 22 | Higher than | Artificial | 0.5% long- | N₂ 300° C. | 32 | 28 | 37 | 60 | No lithium | 90% | 6.30% |
| | 350° C. | graphite | range | | | | | | precipitation | | |
| | | | ceramic | | | | | | at 2.4 C | | |
| | | | fiber | | | | | | | | |
| Example 23 | Higher than | Artificial | 0.5% long- | N₂ 300° C. | 32 | 28 | 38 | 60 | No lithium | 90% | 6.20% |
| | 350° C. | graphite | range | | | | | | precipitation | | |
| | | | aramid | | | | | | at 2.4 C | | |
| | | | fiber | | | | | | | | |
| Comparative | between | Artificial | 0.5% CNT | No | 22 | 41 | 45 | 68 | No lithium | 92% | 6.50% |
| Example 9 | 250° C. and | graphite | | treatment | | | | | precipitation | | |
| | 350° C. | | | | | | | | at 1 C | | |
| Comparative | between | Artificial | 0.5% | No | 22 | 41 | 45 | 68 | No lithium | 90% | 6.20% |
| Example 10 | 250° C. and | graphite | VGCF | treatment | | | | | precipitation | | |
| | 350° C. | | | | | | | | at 1 C | | |
| Comparative | between | Artificial | 1.5% CNT | No | 22 | 41 | 45 | 68 | No lithium | 90% | 6.00% |
| Example 11 | 250° C. and | graphite | | treatment | | | | | precipitation | | |
| | 350° C. | | | | | | | | at 0.6 C | | |
| Comparative | between | Artificial | 0.5% | No | 22 | 41 | 45 | 68 | No lithium | 90% | 6.10% |
| Example 12 | 250° C. and | graphite | CNT + 0.5% | treatment | | | | | precipitation | | |
| | 350° C. | | VGCF | | | | | | at 0.8 C | | |
| Comparative | between | Artificial | 0.5% long- | No | 22 | 41 | 45 | 68 | No lithium | 90% | 6.30% |
| Example 13 | 250° C. and | graphite | range | treatment | | | | | precipitation | | |
| | 350° C. | | ceramic | | | | | | at 1.4 C | | |
| | | | fiber | | | | | | | | |
| Comparative | between | Artificial | 0.5% long- | No | 22 | 41 | 45 | 68 | No lithium | 90% | 6.20% |
| Example 14 | 250° C. and | graphite | range | treatment | | | | | precipitation | | |
| | 350° C. | | aramid | | | | | | at 1.4 C | | |
| | | | fiber | | | | | | | | |

It can be learned from Examples 1 and 18 to 23 that after the long-range fiber is added, the swelling of the negative electrode plate is alleviated. It can be learned from the comparisons between these examples and Comparative Examples 9 to 14 that the negative electrode plate has higher kinetic performance after heat treatment, so that double modifications of alleviating the swelling and improving the kinetic performance are achieved.

In addition, the inventors have found that different types of active materials have different effects on the kinetic performance and electrochemical performance of the lithium-ion battery. In this application, the same materials are used for comparison when the kinetic performance and the electrochemical performance are discussed.

The foregoing descriptions are merely preferable embodiments of this application, but are not intended to limit this application. Any modification, equivalent replacement, or improvement made without departing from the spirit and principle of this application shall fall within the protection scope of this application.

What is claimed is:

1. A negative electrode plate, comprising a negative electrode active material layer, the negative electrode active material layer comprises a negative electrode active material, and an active specific surface area of the negative electrode active material layer is greater than or equal to K·25 cm²/g, wherein K represents a correction parameter, K=15 μm/Dᵥ50, and Dᵥ50 represents a median particle size of the negative electrode active material.

2. The negative electrode plate according to claim 1, wherein a temperature corresponding to a peak height of the first peak on a derivative thermogravimetric curve of a thermogravimetric curve of the negative electrode plate is higher than 350° C.;
wherein the derivative thermogravimetric curve of the thermogravimetric curve is obtained using the following method: cutting the negative electrode plate into small discs with a diameter of 14 mm, performing thermogravimetric analysis test in a nitrogen atmosphere, with a test temperature rising from 25° C. to 600° C. at a temperature rise velocity of 10° C./min, to obtain the thermogravimetric curve, and performing derivative treatment on the thermogravimetric curve to obtain the derivative thermogravimetric curve of the thermogravimetric curve.

3. The negative electrode plate according to claim 1, wherein 100 nm≤Dᵥ50≤30 μm.

4. The negative electrode plate according to claim 1, wherein 10 μm≤Dᵥ50≤30 μm.

5. The negative electrode plate according to claim 1, wherein the negative electrode active material comprises at least one selected from the group consisting of graphite, hard carbon, and a silicon material.

6. The negative electrode plate according to claim 1, wherein the negative electrode active material layer further comprises a long-range fiber, and the long-range fiber comprises one selected from the group consisting of a long-range ceramic fiber, a long-range polymer fiber, and a long-range conductive carbon.

7. The negative electrode plate according to claim 6, wherein the long-range conductive carbon comprises at least one selected from the group consisting of carbon nanotubes and a carbon nanofiber.

8. The negative electrode plate according to claim 6, wherein a length of the long-range fiber ranges from 1 μm to 1 mm.

9. The negative electrode plate according to claim 6, wherein based on a total mass of the negative electrode active material layer, a mass percentage of the long-range fiber ranges from 0.2% to 1.5%.

10. The negative electrode plate according to claim 1, wherein the negative electrode active material layer further comprises a conductive agent; and the conductive agent comprises at least one selected from the group consisting of conductive carbon black, conductive graphite, graphene, and acetylene black.

11. The negative electrode plate according to claim 1, wherein the negative electrode active material layer further comprises a binder; and the binder comprises at least one selected from the group consisting of polyvinylidene fluoride, a vinylidene fluoride-fluorinated olefin copolymer, polyvinylpyrrolidone, polyacrylonitrile, polymethyl acrylate, polytetrafluoroethylene, styrene-butadiene rubber, polyurethane, fluorinated rubber, and polyvinyl alcohol.

12. The negative electrode plate according to claim 1, wherein an electrochemical reaction activation energy Ea of the negative electrode plate satisfies 25 kJ/mol≤Ea≤55 kJ/mol.

13. An electrochemical apparatus, comprises a negative electrode plate, the negative electrode plate comprises a negative electrode active material layer, the negative electrode active material layer comprises a negative electrode active material, and an active specific surface area of the negative electrode active material layer is greater than or equal to K·25 cm²/g, wherein K represents a correction parameter, K=15 μm/Dᵥ50, and Dᵥ50 represents a median particle size of the negative electrode active material.

14. The negative electrode plate according to claim 13, wherein a temperature corresponding to a peak height of the first peak on a derivative thermogravimetric curve of a thermogravimetric curve of the negative electrode plate is higher than 350° C.;
wherein the derivative thermogravimetric curve of the thermogravimetric curve is obtained using the following method: cutting the negative electrode plate into small discs with a diameter of 14 mm, performing thermogravimetric analysis test in a nitrogen atmosphere, with a test temperature rising from 25° C. to 600° C. at a temperature rise velocity of 10° C./min, to obtain the thermogravimetric curve, and performing derivative treatment on the thermogravimetric curve to obtain the derivative thermogravimetric curve of the thermogravimetric curve.

15. The negative electrode plate according to claim 13, wherein 100 nm≤Dᵥ50≤30 μm.

16. An electronic device, comprising the electrochemical apparatus according to claim 13.

17. A method of preparing the negative electrode plate according to claim 1, the method comprising:
applying a slurry of a negative electrode active material layer onto at least one surface of a negative electrode current collector, followed by drying and cold pressing, to produce an initial electrode plate; and
performing a modification treatment on the initial electrode plate to obtain the negative electrode plate; wherein the modification treatment comprises at least one of a plasma treatment, a heat treatment, or a laser treatment.

18. The method according to claim 17, wherein the modification treatment comprises the plasma treatment; the plasma treatment includes: subjecting the initial electrode plate to plasma treatment in a vacuum environment, wherein the plasma treatment is conducted within a power range of 0.5 kW to 5 kW, a gas source comprises at least one of nitrogen, argon, or carbon tetrafluoride, a gas flow rate is within a range of 200 mL/min to 3000 mL/min, a temperature is within a range of 20° C. to 60° C., and a treatment time is within a range of 1 min to 60 min.

19. The method according to claim 17, wherein the modification treatment comprises the heat treatment; the heat treatment includes: placing the initial electrode plate in a vacuum or inert gas environment for heat treatment for 1 min to 60 min at a temperature within a range of 200° C. to 350° C.

20. The method according to claim 17, wherein the modification treatment comprises the laser treatment; the laser treatment includes: treating the initial electrode plate for 1 s to 600 s in a vacuum or inert gas environment, with a laser intensity of 30 W to 100 W.
